(19) United States
(12) Patent Application Publication
(10) Pub. No.: US 2015/0279229 A1
(43) Pub. Date: Oct. 1, 2015

(54) FINGER PLACEMENT TRAINING DEVICE

(71) Applicant: DEAN J. PADDEN, SOUTH RIDING, VA (US)

(72) Inventor: DEAN J. PADDEN, SOUTH RIDING, VA (US)

(21) Appl. No.: 14/242,641

(22) Filed: Apr. 1, 2014

(51) Int. Cl. G09B 11/02; B43L 15/00

(52) U.S. Cl. CPC G09B 11/02; B43L 15/00

(57) ABSTRACT

A finger placement training device is a tool for assisting a child in learning to use handheld implements such as pencils, crayons, pens, forks, spoons and the like that require proper finger placement. The tool may also be of aid to the elderly, individuals who may be recovering from an injury to the hand, or medically-impaired individuals recovering from arthritis, partial paralysis, etc.

### BACKGROUND OF THE INVENTION

1. Field of the Invention

The present invention generally relates to training devices, and particularly to a training device for assisting children in learning the proper handling and use of tools such as pencils, crayon, pens, forks, knives and similar hand-held implements.

2. Description of the Related Art

Teaching a toddler the correct finger placements for gripping an implement such as a pencil, crayon, fork or the like is important in mastering the use of the particular implement, Proper use of the implement will bolster self-confidence and encourage continued use, thus possibly enhancing intellectual curiosity and social skills. Consistency based on muscle memory is a major problem in teaching the above-mentioned finger placement in that the fingers and thumb should be positioned at approximately the same place on the implement at each use. Consistent finger placement positioning is a learned skill that is developed over time by repeated practice. A device that would speed up the learning curve while instilling confidence in the toddler would be a welcome developmental tool in the art. Thus, a finger placement training device solving the aforementioned problem is desired.

### SUMMARY OF THE INVENTION

The finger placement training device is a tool for assisting a child in learning to use handheld implements that require proper finger placement. Implements such as pencils, crayons, pens, forks, spoons and the like are items that a child must learn to use properly. The invention comprises a tube preferably having perforations therethrough. The tube is mounted on the shaft of the implement. Finger placement devices are removably mounted on the tube in pre-determined locations. Each finger placement device includes an adjustable ring or loop adapted to receive therein a finger or thumb. The location of each finger placement device and the adjustment of the ring are dependent on the type of implement to be used. It has been determined that a maximum of three rings mounted on the tube is sufficient to teach proper finger placement for substantially all implements.

Accordingly, the finger placement training device enables a child to learn proper finger positioning when using certain implements. In addition to assisting children, the finger placement device may also be of aid to the elderly, individuals who may be recovering from an injury to the hand, or medically-impaired individuals recovering from arthritis, partial paralysis, etc. As contemplated, the device may be manufactured in different sizes to accommodate use on a variety of implements. The device may be manufactured from suitable non-toxic and reasonably rugged materials and is applicable for use by either the right or left hand.

These and other features of the present invention will become readily apparent upon further review of the following specification and drawings

### BRIEF DESCRIPTION OF THE DRAWINGS

FIG. 1 is an environmental, perspective view of a finger placement training device according to the present invention.

FIG. 2 is a perspective view of a first embodiment of a finger placement training device according to the present invention.

FIG. 3 is an exploded, perspective view of a second embodiment of a finger placement training device according to the present invention.

FIG. 4 is a partial, perspective view of the second embodiment of a finger placement training device showing details of the ring insertion slot according to the present invention.

Similar reference characters denote corresponding features consistently throughout the attached drawings.

### DETAILED DESCRIPTION OF THE PREFERRED EMBODIMENTS

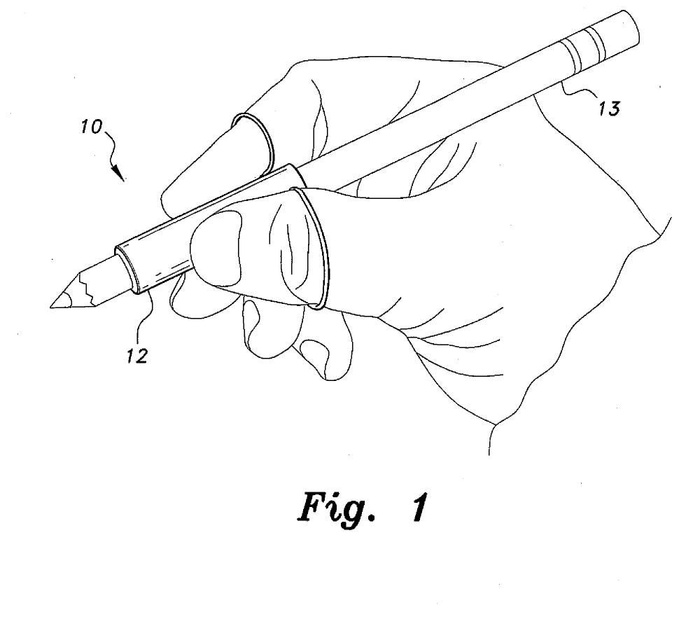

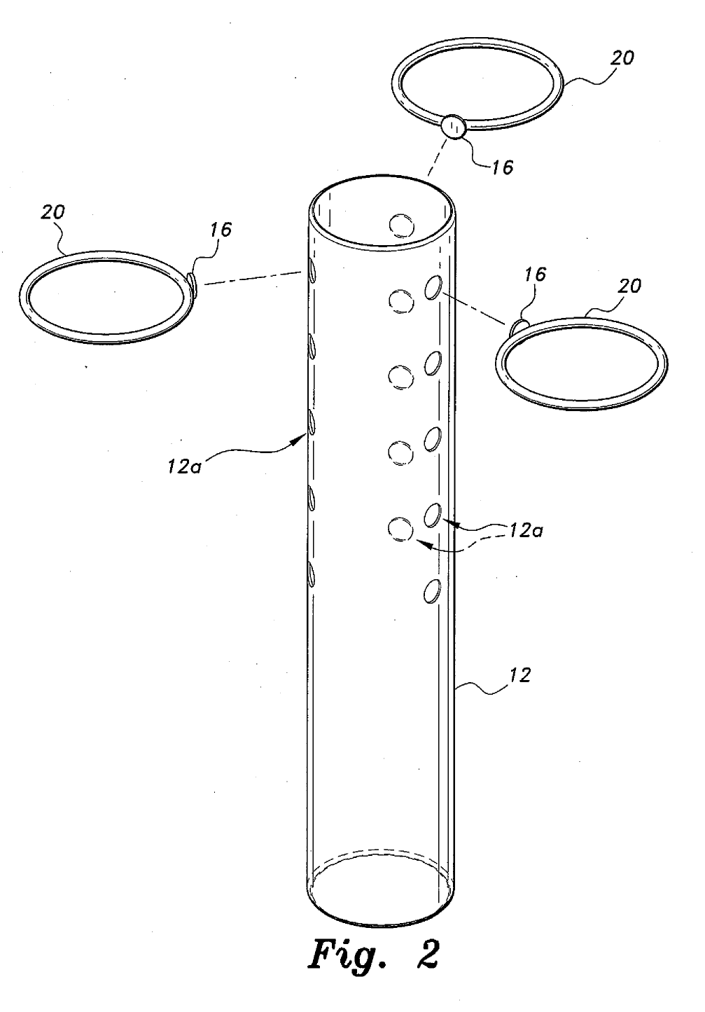

With reference to FIGS. 1 and 2, a first embodiment of the finger placement training device is generally indicated at 10. The device 10 comprises a tube 12 preferably having perforations 12a therethrough. The perforations are arranged along the entire surface of the tube 12 for reasons as will be fully explained below. Tube 12 is adapted to be mounted on the shaft of an implement 13. Tube 12 may be formed to snugly fit around the shaft of the implement or hook-and-loop fasteners (not shown) may be used to secure the device 10 to the implement 13. The tube 12 may be designed in hemispherical sections (half-pipes) if desired, having suitable means for joining the sections to surround the implement 13. Although illustrated as a pencil, it should be recognized, as indicated above, that the implement 13 can be any one of many types of implements. Finger rings 20 are provided for removable securement to tube 12. Each finger ring is adjustably mounted to a securing pin 16, which pin can be inserted in a chosen aperture 12a whereby the ring 20 is secured to the tube. A maximum of three rings mounted on the tube will be adequate for providing finger placement.

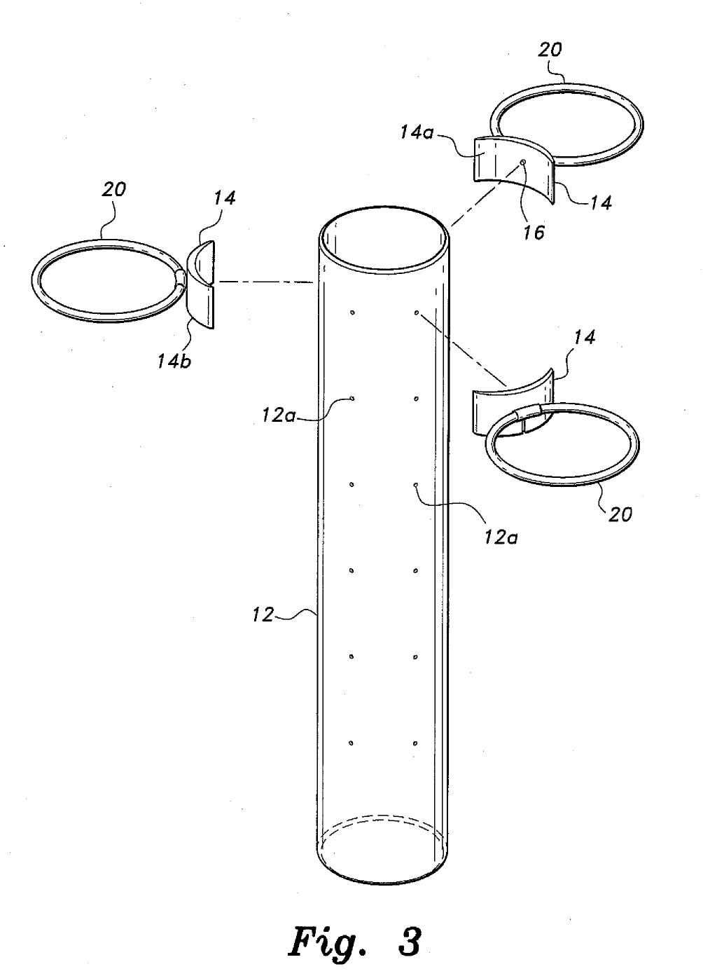

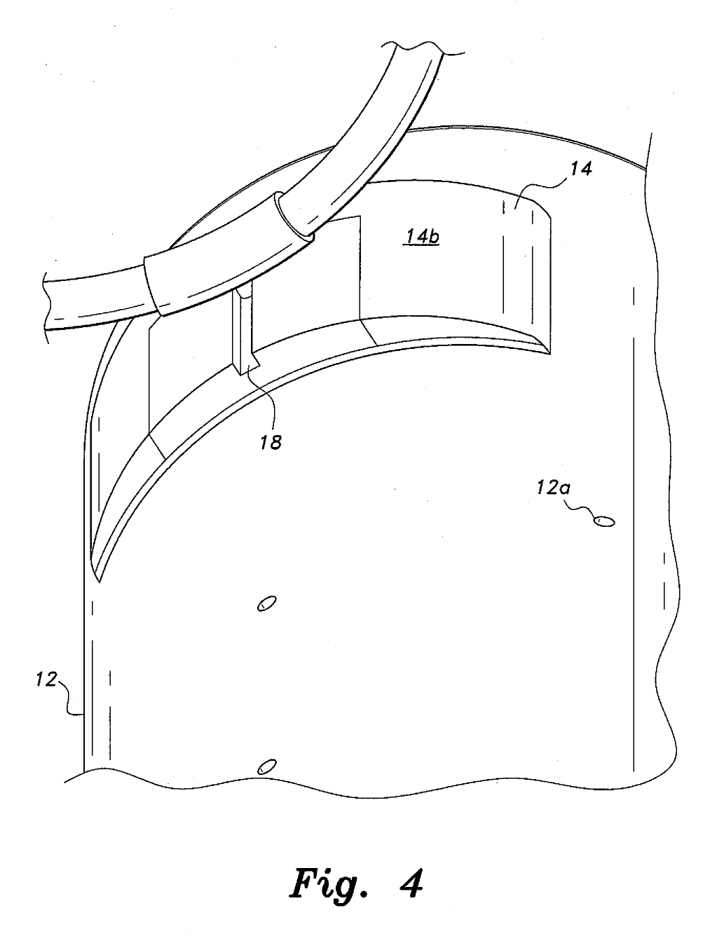

FIGS. 3 and 4 show a second embodiment of the invention wherein arcuate-shaped plates 14 are adapted to be removably mounted on tube 12. Each plate has an inner concave surface 14a provided with a mounting pin 16 thereon. Mounting pin 16 is adapted to penetrate a selected one of the perforations 12a to secure the plate 14 to the tube 12. An outer convex surface 14b of plate 14 is provided with a slot 18 for removably receiving a finger ring 20 therein. Finger ring 20 is pivotally adjustable in slot 18. Alternate means such as hook and loop fasteners may be employed to removably attach the plates to the tube if desired. The plates provide for a more stable support surface for the rings.

In use, the tube 12 is mounted on the shaft of an implement. Finger rings 20 are positioned on the tube in predetermined locations that are dependent on the type of implement and finger size of the individual using the device. Finger rings 20 are adjusted in accord with the desired finger placement. The user inserts the proper fingers and thumb in the rings for proper placement.

It is to be understood that the present invention is not limited to the embodiments described above, but encompasses any and all embodiments within the scope of the following claims.

1. A finger placement training device, comprising:
a hollow tube having a length and a cylindrical surface, the tube adapted to surround the shaft of an implement;
a plurality of perforations positioned along the length of and around said cylindrical surface;
at least one ring structure mounted on said cylindrical surface; and
means for removably mounting said ring structure to said cylindrical surface.

2. The finger placement training device according to claim 1, wherein said means comprises a mounting pin attached to said ring structure for mounting the ring structure to said tube.

3. The finger placement training device according to claim 1, wherein said means comprises a mounting plate is of arcuate-shaped configuration having a concave inner surface and a convex outer surface and further including a mounting pin fixed on said concave inner surface for attaching the mounting plate to the tube.

4. A finger placement training device, comprising:
a hollow tube having a length and a cylindrical surface, the tube adapted to surround the shaft of an implement;
a plurality of perforations positioned through said surface along the length of and around said cylindrical tube;
three finger ring structures removably mounted to said cylindrical tube; and
a respective mounting pin attached to each finger ring structure for mounting said finger ring structures to said tube.

5. The finger placement training device according to claim 4, wherein each respective mounting pin is adapted to penetrate the perforated surface for securing the finger ring structure on the surface and wherein said finger ring structure is adjustably mounted to said mounting pin.

6. A finger placement training device, comprising:
a hollow tube having a cylindrical, perforated surface, the tube adapted to surround the shaft of an implement;
three mounting plates removably attached to the cylindrical surface of the tube, each of the mounting plates having an arcuate-shaped configuration, a concave inner surface and a convex outer surface;
a respective adjustable ring structure removably mounted to each mounting plate;
a respective mounting pin fixed on each concave inner surface, the mounting pin adapted to penetrate the perforated surface for securing the plate on the surface; and
a slot formed in each outer surface for engaging the respective adjustable ring structure.
